(19) United States
(12) Patent Application Publication
(10) Pub. No.: US 2011/0208836 A1
(43) Pub. Date: Aug. 25, 2011

(54) Document Sharing Using a Third-Party Document Delivery Service

(76) Inventors: John O'Fallon, Lakewood, IL (US); Benjamin Nager, Lakewood, IL (US)

(21) Appl. No.: 12/711,153

(22) Filed: Feb. 23, 2010

(51) Int. Cl. G06F 15/16; G06F 17/00; G06F 3/048; G06F 3/12

(52) U.S. Cl. 709/219; 709/246; 715/230; 715/830; 358/1.15

(57) ABSTRACT

A virtual printer which includes a document transfer function can be activated within an application program using the standard operating system print mechanism. When the user selects the virtual printer, the software performs the steps of converting the document to a standard display file, requesting a document delivery from a database server, receiving a unique identifier and a name of a file server, uploading the standard display file corresponding to the document, to the named file server, using the unique identifier as the storage identifier, and displaying, in an outbox, an indication that the document was sent. At a remote site, a Document Delivery Service is configured to perform the steps of accepting document delivery requests, initiating such requests, responding with file transfer instructions (including a unique identifier), receiving the uploaded file, storing the file, accepting polling inquiries received from potential document recipients, responding with a list of available documents addressed to each potential recipient, and enabling the recipient computer to download the standard display file. To ensure confidentiality and avoid tampering or forgery, all communication and data transfers between the client computers and the managed file transfer service carried out over secure network connections.

### FIELD OF THE INVENTION

The present invention relates to techniques for document management, and, more particularly for document sharing using a third-party document delivery service.

### BACKGROUND

In the healthcare industry, the privacy rules set forth in the Health Insurance Portability and Accountability Act (HIPAA) mandate that any individually identifiable health information must be maintained in strict confidence. Thus, health care providers which send such information using conventional email systems risk liability. Similar concerns are raised when lawyers share confidential documents, and, in general, whenever documents of a confidential nature are to be shared.

Because of the problems associated with conventional document transfer methods, many documents are still sent by fax, mail or courier. However, this is expensive, slow, and difficult to manage.

### SUMMARY OF THE INVENTION

A virtual printer which includes a document transfer function can be activated within an application program using the standard operating system print mechanism. When the user selects the virtual printer, the software performs the steps of converting the document to a standard display file; requesting a document delivery from a database server; receiving a unique identifier and a name of a file server; uploading the standard display file corresponding to the document, to the named file server, using the unique identifier as the storage identifier; and displaying, in an outbox, an indication that the document was sent.

At a remote site, a document delivery service is configured to perform the steps of accepting document delivery requests, initiating such requests, responding with file transfer instructions (including a unique identifier), receiving the uploaded file, storing the file, accepting polling inquiries received from potential document recipients, responding with a list of available documents addressed to each potential recipient, and enabling the recipient computer to download the standard display file. To ensure confidentiality and avoid tampering or forgery, all communication and data transfers between the client computers and the document delivery service are carried out over secure network connections.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows an exemplary diagram of a system for document sharing using a third-party document delivery service, according to a preferred embodiment of the present invention;

FIG. 2(a) shows a block diagram of a computer system having a virtual print driver installed capable of document conversion and transfer;

FIG. 2(b) shows a block diagram of a computer system having a recipient application installed capable of receiving a document;

FIG. 3 shows an exemplary dialog box for selecting a document to send to a recipient;

FIG. 4 shows an example window including twin inbox/outbox; and

FIG. 5 illustrates an example of a document transfer from a sender computer to a recipient computer using a third-party document delivery service.

### DETAILED DESCRIPTION

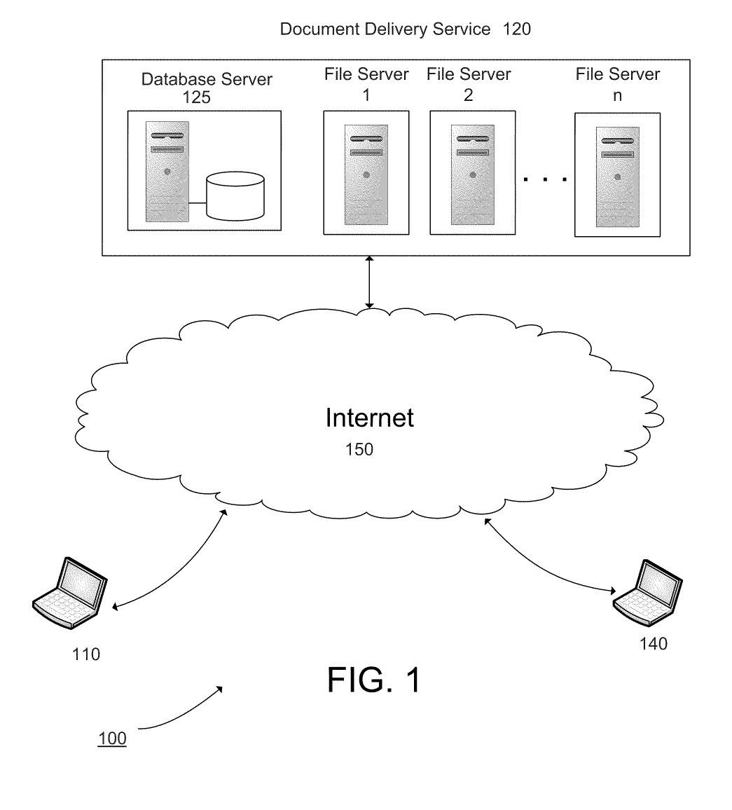

FIG. 1 illustrates a system 100 that uses a third-party Document Delivery Service 120 to securely transfer documents. As depicted, the system 100 includes a sender computer 110, a recipient computer 140, and the Document Delivery Service 120. The Document Delivery Service 120 includes a database server 125 and a plurality of file servers 1-n. As will be described in greater detail, both the sender computer 110 and the recipient computer 140 are communicatively coupled, via the Internet 150, to the Document Delivery Service 120. The present invention allows a user of the sender computer 110 to send documents to a user of the recipient computer 140, using the Document Delivery Service 120 as an intermediary.

To achieve the primary objects of the present invention, three distinct components are used: a virtual print driver 111 (loaded into memory of the sender computer 110), which converts a computer document into a standard display format; the Document Delivery Service 120; and a recipient application (loaded into memory of the recipient computer 140) which lists, displays and manages received documents. It is to be understood that the term “standard display format” means any file format that both the sender computer 110 and the recipient computer 140 recognize. For example, a document in Microsoft Word format could be converted by the virtual print driver 111 into Adobe PDF format, and the recipient computer 140, having the necessary software to read the file in Adobe PDF format, would be able to properly access this file. Other suitable standard display formats include, but are not limited to, XPS, JPEG, and GIF.

It is to be appreciated that although FIG. 1 shows only two end-user computers 110, 140, the Document Delivery Service 120 could be configured to manage document transfers for a large number of end-user computers. Furthermore, it is to be understood that any of the end-user computers could be configured to both send and receive documents. Accordingly, it is to be understood that the arrangement shown in FIG. 1 is presented for simplicity of exposition rather than actual or intended usage.

### Virtual print driver (111)

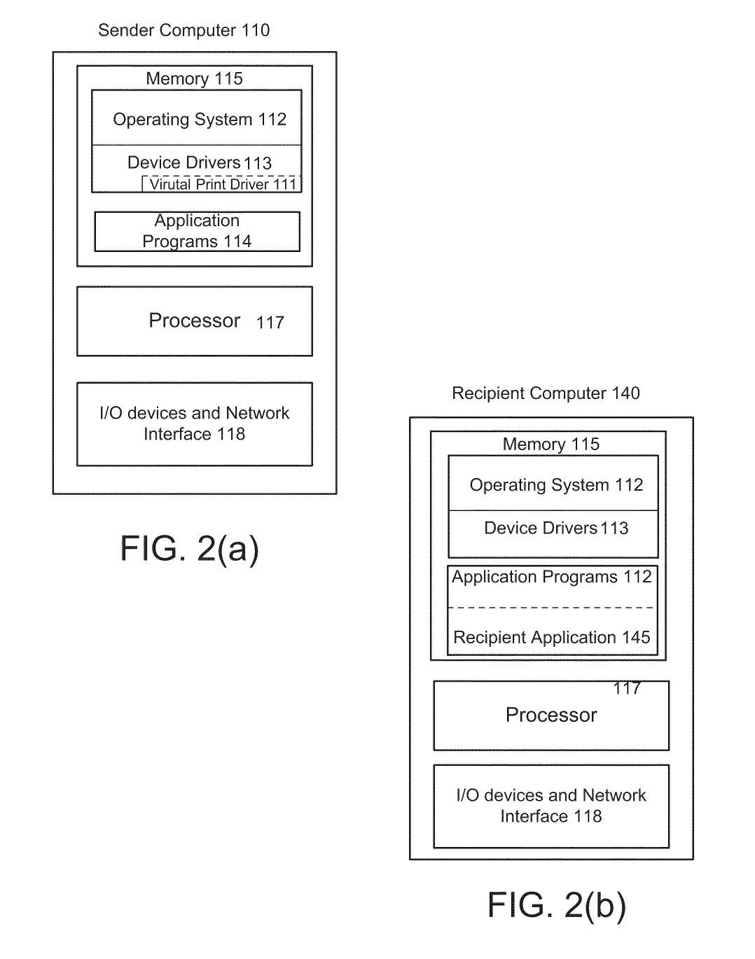

FIG. 2(a) depicts the virtual print driver 111 loaded into a portion of memory of the sender computer 110 that is reserved for device drivers 113.

In addition to converting file data to a standard display format, the virtual print driver 111 provides a human interface which allows for the selection of document transmission options, including intended recipient, delivery priority and confirmation, etc. In particular, the recipient (“destination”) is selected from a list of people to whom documents have previously been sent from the sender computer. Any other recipient known to the network can be added to the list using a partial name match search of the known recipients' database. Once a document has been printed and addressed, it is moved into the Document Delivery Service 120.

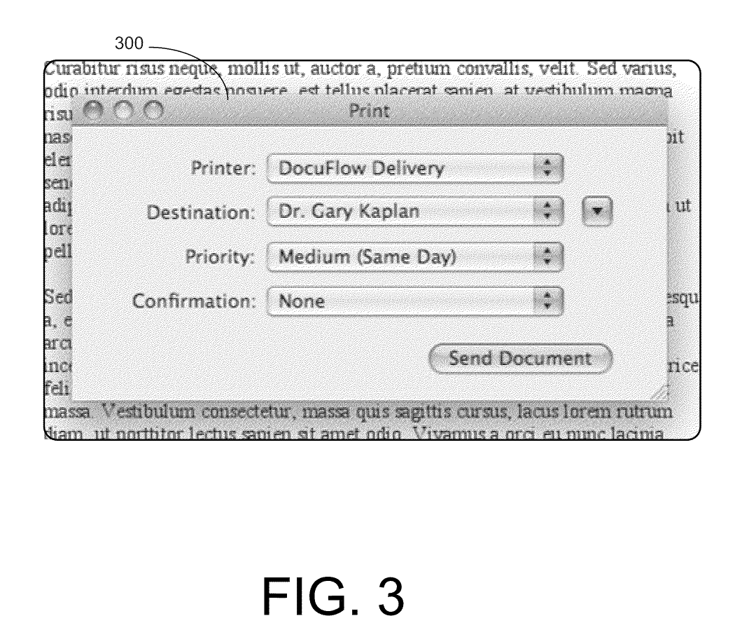

FIG. 3 shows an exemplary dialog box 300 for selecting a document to send to a recipient

### Document Delivery Service (120)

The Document Delivery Service 120, which is run and maintained by a third party, provides for secure, managed transmission of files between the virtual print driver 111 and the recipient application 145. An encrypted request is made from the sender computer 110 to the database server 125, initiating the transfer. The response of the database server 125 includes instructions for transfer of the file, including a unique transfer ID and the hostname of the transfer server to which the homogenized data file should be sent. The data file is transferred via encrypted channel to the server specified in the transfer initiation response, which is also run by the third party. Upon completion of the file transfer, the sender computer 110 sends another database request via encrypted channel, marking the transfer record in the database as ready for delivery.

### Recipient Application (145)

FIG. 2(b) depicts the recipient application 145 loaded into a portion of memory of the sender computer 110 that is used for application programs 112.

The recipient application 145 is run on each recipient computer 140 in the network. The recipient application 145 periodically queries the database server 125 for documents sent to the user logged in to the recipient application on the recipient computer 140, and displays a list of all recently delivered documents. The recipient application 145 allows for simple display of each document, as well as additional services including forwarding documents, removing them from the list, saving them to a permanent location on the recipient computer 140, etc.

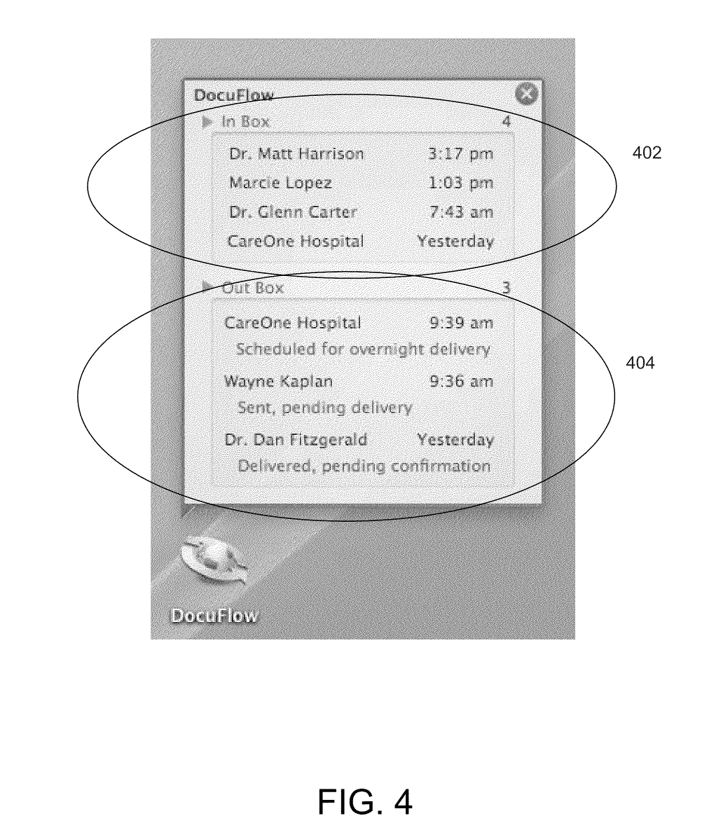

A notable feature of the present invention is that access to a document by a subscriber requires use of neither a Web browser nor an email system. Preferably, this is accomplished by executing a program in the background on each computer system which displays a small “pop up” having an “in box” and an “outbox” (the outbox being for subscribers only). FIG. 4 shows an exemplary twin inbox/outbox 400. Note that inbox 402 and outbox 404 are arranged adjacently so as to provide convenient access thereto. It is also to be noted that summary information (e.g., number of messages in the box, delivery status, confirmation status, etc.) are displayed for both the inbox 402 and the outbox 404.

Importantly, all communication between the client computers (such as the sender computer 110 and the recipient computer 140) and the managed file transfer service 120 uses a secure connection, preferably, a secure sockets layer (SSL) connection. Thus, document confidentiality is assured. Advantageously, transferred medical documents, for example, will comply with HIPAA confidentiality requirements. Additionally, responsive to a request by the document recipient, a copy of the stored document can be copied to an external database, such as, for example, an Electronic Medical Record (EMR) database (for healthcare information). Furthermore, preferably, stored documents are automatically deleted after a predetermined length of time (e.g., 30 days). Alternatively, the stored standard display file could be automatically archived after a predetermined length of time.

Another notable and distinguishing feature of the present invention is that documents can be annotated. For example, a radiologist might wish to include patient notes corresponding to a radiological image that he or she wishes to send to another physician. In such a case, the notes can be provided as freeform text and stored in an SQL record associated with the document. Furthermore, notes can be appended to a document transfer entry by either the sender or recipient for display on both computers.

In addition to a printable document, the user is able to transfer one or more files to a user by ‘dropping’ an icon associated with the file into their ‘out box’. In this case, the native file is delivered through the system as described, but without conversion to the standard display format.

Alternatively, documents can be accessed by the recipient via a Web site, rather than through the use of a dedicated application executed on the recipient computer.

Another notable and distinguishing feature of the present invention is that messages can be, optionally, confirmed when received. Also, preferably, copies of a document can be sent to multiple recipients. Additionally, the sender can select a fax machine as an alternate to the delivery method outlined herein.

It is to be appreciated that the present system is capable of expansion such that additional database servers and file servers may be added, as needed. Furthermore, it is to be understood that although the database server 125 is shown separately from the file servers 1-n, the database server 125 could share the same physical server with one of the file servers 1-n. Additionally, it is to be understood that one or more file server 1-n could be a virtualized device. Accordingly, the architecture shown in FIG. 1 is meant to be illustrative, not limiting.

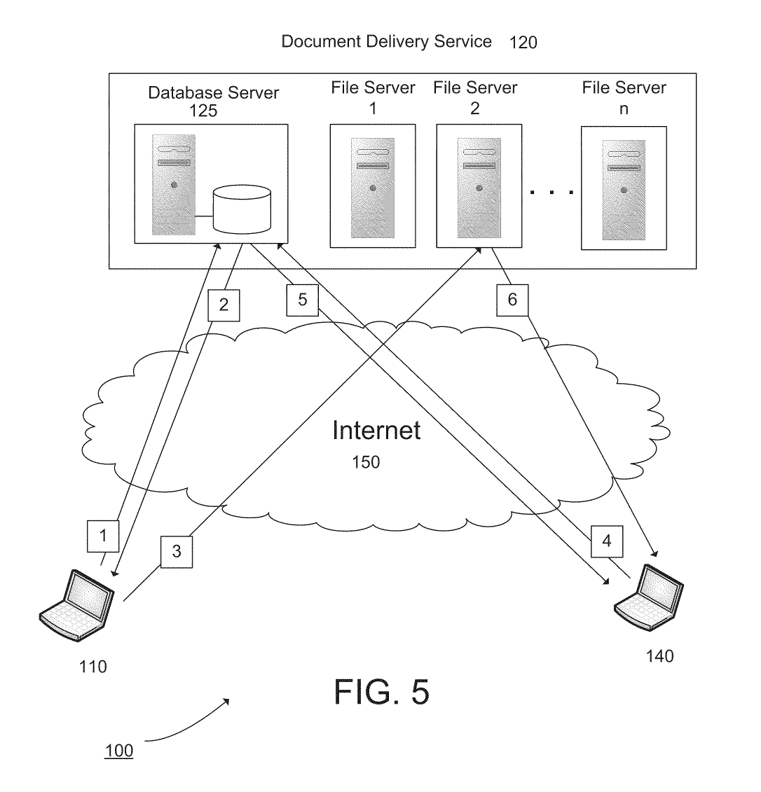

With reference to FIG. 5, an example of a document transfer from the sender computer 110 to the recipient computer 140 is provided.

### EXAMPLE

Dr. Smith, a radiologist at Midtown Hospital, wishes to deliver a copy of a radiological image of a patient to Dr. Jones, a physician who is situated in another part of the city. While Dr. Smith is using an application program to view the image, he selects from a printer menu a document transfer function and identifies Dr. Jones as the recipient. Responsive to this selection, the virtual print driver causes the medical image to be converted to an XPS file.

Step 1: The sender computer 110 initiates a database request, requesting a file transfer.

Step 2: The database server 125 returns a unique transfer ID and the name of a file server for the upload.

Step 3: The sender computer 110 uploads the XPS file to the specified server, using the specified transfer ID as the storage ID (filename). An indication that the file was sent to Dr. Jones is placed in Dr. Smith's outbox.

Step 4: The recipient computer 140 periodically polls the database server 125 for document transfers marked for delivery to the person logged in to the client application, Dr. Jones.

Step 5: The database server 125 replies with a list of files addressed Dr. Jones 140.

Step 6: The recipient computer 140 performs the download as directed by the database server 125. An indication that the file was received is placed in Dr. Smith's inbox.

In the above example, industry standard SSL encryption is used for both database connections and file transfers. The file transfers are sent using Web-based Distributed Authoring and Versioning (WebDAV) over Hypertext Transfer Protocol Secure (HTTPS), configured both on the web server and client application levels.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A computer-readable medium which stores a set of instructions which when executed performs the steps necessary to print a document in a form specific to a selected printer or, responsive to a user instead selecting a document transfer function, requests a file transfer from a database server, receives a name of a file server, uploads a file corresponding to the document, to the named file server, and displays, in an outbox, an indication that the document was sent.

2. A system for managing document transfers, comprising:
(a) a plurality of computer systems each associated with a document delivery service, each one of the computer systems having installed a virtual printer driver configured to perform the steps of
(i)) in an application program with a document open, displaying a dialog box to a document sender, the dialog box for identifying a document recipient;
(ii) converting the document to a standard display format;
(iii) requesting a file transfer from a database server;
(iv) uploading the standard display file converted from the document, to the named file server; and
(v) displaying, in an outbox, an indication that the document was sent; and
(b) at a remote site, the document delivery service, configured to perform the steps of:
(i) receiving the uploaded standard display file;
(ii) storing the received standard display file in a database managed by the database server;
(iii) responsive to a polling inquiry received from the document recipient, accessing from the database server a list of documents addressed to the recipient; and
(ii) transferring the standard display file to the document recipient.

3. The system of claim 2, wherein access to the document by the document sender and the document recipient involves use of neither a Web browser nor an email system.

4. The system of claim 2, wherein one or more of the steps are performed using a secure sockets layer (SSL) connection.

5. The system of claim 2, wherein, responsive to a request by the document recipient, a copy of the stored standard displays files is imported to an Electronic Medical Record (EMR) database.

6. The system of claim 2, further including allowing the document sender to annotate the document.

7. The system of claim 2, wherein the stored standard display file is automatically deleted after a predetermined length of time.

8. A method for securely transferring a document, comprising:
at a first site,
(a) in an application program with the document open, displaying a virtual printer dialog box to a sender, the virtual printer dialog box for identifying a recipient
(b) converting the document to a standard display format;
(c) requesting a file transfer from a database server;
(d) receiving a name of a file server;
(e) uploading the standard display file converted from the document, to the named file server; and
(f) displaying, in an outbox, an indication that the document was sent;
(g) wherein the database server and the file server are located at a second site, the second site remote from the first site.

9. The method of claim 8, further comprising:
at the second site,
(h) storing the uploaded standard display file in a database managed by the database server;
(i) responsive to a polling inquiry received from the recipient, accessing from the database server a list of documents addressed to the recipient; and
(j) transferring the standard display file to the recipient;
(k) wherein the recipient is located at a third site, the third site remote from both the first site and the second site.

10. The method of claim 9, further comprising:
at the third site,
(l) displaying, in an inbox, an indication that the document was received.

11. The method of claim 9, further comprising:
at the second site,
(m) sending confirmation to the sender that the document was received.

12. The method of claim 10, further comprising:
at the first site,
(n) receiving confirmation that the document was received.

13. The method of claim 9, wherein the stored standard display file is automatically deleted after a predetermined length of time.

14. The method of claim 8, wherein the uploading step further includes transmitting a unique identifier obtained from the database server to the named file server, the unique identifier for use in identifying the uploaded standard display.

15. The method of claim 8, wherein the steps (c) to (e) are performed using a secure sockets layer (SSL) connection.

16. The method of claim 9, wherein the steps (h) and (i) are performed using a secure sockets layer (SSL) connection.

17. The method of claim 8, wherein displaying a printer dialog box to a user is performed by a printer device driver.

18. The method of claim 18, wherein the printer dialog box includes a plurality of printer devices selectable from a scrollable list.

19. The method of claim 10, further including indicating multiple recipients.

20. The method of claim 8, wherein the outbox includes an inbox adjacent thereto.
